(19) United States
(12) Patent Application Publication
(10) Pub. No.: US 2025/0297685 A1
(43) Pub. Date: Sep. 25, 2025

(54) THREE-WAY VALVE

(71) Applicant: CLEAN AIR POWER GT LIMITED, Melton Mowbray, Leicestershire (GB)

(72) Inventors: Dan SKELTON, Melton Mowbray, Leicestershire (GB); Neil SULLY, Bispham, Lancashire (GB); Ed NEWMAN, Melton Mowbray, Leicestershire (GB)

(21) Appl. No.: 18/863,551

(22) PCT Filed: May 9, 2023
(86) PCT No.: PCT/GB2023/051215

§ 371 Date: Nov. 6, 2024

(30) Foreign Application Priority Data
May 9, 2022 (GB) 2206776.3

(51) Int. Cl. F16K 11/048; F16K 11/056; F16K 31/06

(52) U.S. Cl. CPC F16K 11/048; F16K 11/056; F16K 31/0631

(57) ABSTRACT

A three-way valve is provided. The three-way valve comprises a housing having three successive openings interconnected by a fluid flow path; a vent ball and a corresponding vent ball seat; a supply ball and a corresponding supply ball seat; and a separator pin between, and configured to bear against, the vent ball and the supply ball. The valve further comprises: a resilient element for biasing the supply ball towards the supply ball seat. A damper is also provided.

### TECHNICAL FIELD

The present disclosure relates to a three-way valve. In particular, the disclosure relates to a three-way valve comprising a resilient element for biasing a supply ball towards a corresponding supply ball seat.

### BACKGROUND

Three-way valves are used for controlling the flow of a fluid. Actuation of the three-way valve directs the flow of fluid along one pathway, and lack of actuation directs the flow of fluid along another pathway.

Actuation is often controlled by a solenoid. For example, in three-way solenoid valves, upon the solenoid being actuated or energized, fluid flow is directed along one pathway, and upon the solenoid not being actuated or de-energized, fluid flow is directed along another pathway.

The directing of fluid flow is accomplished by pushing a first valve ball onto its corresponding ball seat at the same time as pushing a second valve ball off its corresponding ball seat. Three-way solenoid valves similar to the ones according to the present disclosure typically use a pressure differential to close the valve, by using the pressure differential to push the second ball back onto the corresponding seat.

Such three-way valves may be used to control the flow of hydraulic fluid into a hydraulic cylinder which engages various parts of a transmission, and directly varies vehicle speed. Release of the fluid from the hydraulic cylinder is also controlled by the valve. Three-way valves may also be used in environments with significant environmental disturbance, e.g. in dampers, robotics, or hydraulic power take off systems, e.g. for vehicles.

Significant environmental disturbance, however, has been found to negatively impact the reliability of some prior art three-way solenoid valves.

The inventors have appreciated the need for a three-way valve that can more reliably be used in environments with significant environmental disturbance.

### SUMMARY OF THE DISCLOSURE

The present disclosure provides a three-way valve and a damper, as defined in the appended claims, to which reference should now be made.

According to a first aspect of the present disclosure, there is provided a three-way valve. The three-way valve comprises a housing having three successive openings interconnected by a fluid flow path, the fluid flow path having: a first chamber between a first and a second of the three successive openings, and a second chamber between the second and a third of the three successive openings. The three-way valve further comprises a vent ball and a corresponding vent ball seat adjacent the first chamber; a supply ball and a corresponding supply ball seat adjacent the second chamber; and a separator pin between, and configured to bear against, the vent ball and the supply ball. The vent ball seat, the vent ball, the supply ball seat, the supply ball, and the separator pin are functionally linked so that when one of the vent ball and the supply ball is seated against the corresponding ball seat, the other of the vent ball and the supply ball is off its corresponding ball seat. The valve is configurable between a default position, in which the second opening is in fluid communication with the first opening, and an actuated position in which the second opening is in fluid communication with the third opening. The valve further comprises a resilient element for biasing the supply ball towards the supply ball seat.

When prior art three-way solenoid valves are used in applications with significant environmental disturbance, the supply ball may be thrown off the corresponding ball seat, due to either external forces or fluid forces (e.g., due to venting). This may cause the operating time of the valve to increase, preventing precise control, as the opening time of the valve will vary depending on how far away the supply ball is from the corresponding ball seat.

By adding a resilient element for biasing the supply ball towards the supply ball seat, return of the supply ball to the supply ball seat is supported. In this way, independently of environmental disturbance or fluid forces, the supply ball will remain on the supply ball seat until the vent is actuated, so that a response time is the same throughout operation of the valve.

The resilient element does not adversely affect operation of valve, and the supply ball would return to the supply ball seat without the resilient element, however, due to provision of the resilient element, the supply ball is assisted in returning to the supply ball seat, ensuring consistent performance even in environmentally unfriendly applications.

The resilient element biasing the supply ball towards the supply ball seat may refer to the resilient element centring the supply ball and exerting a biasing force on the supply ball which acts towards the supply ball seat.

The three-way valve may be particularly suitable for applications with significant environmental disturbance. For example, the three-way valve may be, in particular, suitable for a damper, such as a suspension damper. The three-way valve may also or alternatively be, in particular, suitable for low-gravity applications.

As set out above, the valve is configurable between a default position, in which the supply ball is seated, and an actuated position, in which the vent ball is seated. Preferably, the vent ball is couplable to an actuator, such that movement of the actuator causes the vent ball, the separator pin, and the supply ball to move to reconfigure the valve from the default position to the actuated position.

Optionally, the resilient element comprises a coil spring. In particular, the resilient element may be a coil spring. Advantageously, a coil spring is a widely available component which is easily adaptable to an appropriate biasing force by selecting a coil spring with suitable properties.

Optionally, the coil spring is sized to receive a portion of the supply ball. This means that the internal diameter of the coil spring and the external diameter supply ball are similar, but not equal. For example, when the internal diameter of the coil spring is slightly smaller than the diameter of the supply ball, the supply ball cannot be received entirely within the coil spring, but the diameters are similar enough that a proportion of the supply ball may be received by the spring.

Advantageously, this allows for the coil spring to limit movement of the supply ball away from the supply ball seat and keep the supply ball orientated correctly, so that the supply ball remains centred. In other words, the relative sizes of the spring and the ball are such that the ball sits in the spring and is retained by the spring so that no additional components are needed for keeping the supply ball in the supply ball seat.

Optionally, a diameter of the supply ball is larger than an internal diameter of the coil spring by about 1% to 70%. Further optionally, the diameter of the supply ball is larger than the internal diameter of the coil spring by about 2% to 60%, or by about 5% to 50%. Further optionally, the diameter of the supply ball is larger than the internal diameter of the coil spring by about 10% to 45%, or by about 20% to 40%, or by about 30% to 38%.

Optionally, the diameter of the supply ball is larger than the internal diameter of the spring by about 34%. Advantageously, the diameter of the supply ball being about 34% larger than the internal diameter of the coil spring may provide a beneficial trade-off between a large portion of half of the supply ball fitting into the coil spring for centring purposes but there being no risk of the supply ball being jammed into the coil spring.

Optionally, the diameter of the supply ball is between about 80% and about 120% of the external diameter of the spring. Optionally, the diameter of the supply ball is between about 90% and about 110% of the external diameter of the spring.

Optionally, a preload of the coil spring is between about 0.1 N and 10 N. Further optionally, the preload is between about 0.5 and 5 N. Further optionally, the preload is between about 1 N and 3 N. Yet further optionally, the preload is between about 1.9 N and 2.1 N.

Optionally, the preload of the coil spring is about 2 N. Advantageously, a light preload is sufficient to guide the supply ball onto the supply ball seat but does not affect the operation of the valve, i.e. it is not sufficient to provide sealing. The preload may be about 0.4477 lbf.

Optionally, a spring constant of the coil spring is between about 0.1 N/mm and 10 N/mm. Further optionally, the spring constant is between about 1 N/mm and 5 N/mm. Further optionally, the spring constant is between about 1.5 N/mm and 3 N/mm. Yet further optionally, the spring constant is between about 2 N/mm and 2.5 N/mm.

Optionally, the spring constant of the coil spring is about 2.2 N/mm. Advantageously, a light spring constant is sufficient to guide the supply ball onto the supply ball seat but does not affect the operation of the valve, i.e. it is not sufficient to provide sealing. The spring constant may be about 12.1 lbf/in.

The combination of the light preload and the light spring constant may beneficially allow the spring to assist the supply ball in remaining in the supply ball seat without affecting the operation of the valve.

Optionally, the valve further comprises a holder for retaining the spring. Advantageously, a holder may ensure that the spring remains in the required position and orientation, e.g. to maintain the supply ball centred on the supply ball seat.

Further optionally, the holder comprises a cavity, and the spring is arranged within the cavity such that movement of the spring is guided by the holder. Advantageously, arranging the spring within a cavity in the holder may protect the spring from interference, and may ensure that the spring remains in the required position and orientation even when slightly deformed during operation of the valve.

Yet further optionally, the spring is fully retained within the cavity. Advantageously, the cavity being sized to fully retain the spring within the cavity may allow for the spring to be securely guided upon deformation during operation of the valve.

The holder may alternatively be referred to as a retainer, or a guide, or a guidance element.

Optionally, the holder may be configured to be press-fit into the valve. For example, the holder may be sized, and made of a material, so that it can be press-fit into the valve so as to be positioned to retain and guide the spring. Advantageously, the holder may thus be easily inserted into, and retained in, the valve.

Optionally, the holder may be made of a resilient material. Advantageously, a resilient holder may allow the holder to be press-fit.

Alternatively to being a coil spring, the resilient element may comprise at least three, evenly distributed, elements, each having a resilient tip. Advantageously, providing three, or more, evenly distributed elements each having a resilient tip may allow for a resilient element which does not require a holder. Additionally, such a resilient element may be easily adapted to a desired preload and stiffness.

If three, evenly distributed, elements are provided, they are provided around a diameter at 120 degree intervals. It is apparent to those skilled in the art that if four, evenly distributed, elements are provided, they are provided around a diameter at 90 degree intervals, and so on for five, six, or more elements.

Optionally, a diameter of the supply ball is larger than a diameter formed by the at least three resilient tips of the resilient element by about 1% to 50%, or about 20%, or about 34%.

Optionally, a combined stiffness of the at least three resilient tips is between about 1 N/mm and 5 N/mm, optionally about 2.2 N/mm. Advantageously, a light spring constant is sufficient to guide the supply ball onto the supply ball seat but does not affect the operation of the valve, i.e. it is not sufficient to provide sealing.

Optionally, a force of the resilient element acting on the supply ball in the default position is about 0.1 N and 10 N, or about 2 N. Advantageously, such a light force at default position is sufficient to guide the supply ball onto the supply ball seat but does not affect the operation of the valve.

The resilient element may comprise a resilient net. The net may be attached to contain the supply ball so that the net biases the supply ball towards the supply ball seat.

Any feature of the coil spring described above, including parameter ranges and specific values for spring rate, preload, and relative diameter, may be applied equally to resilient elements comprising a resilient net or at least three, equally distributed, elements.

Optionally, the valve is configured so that a hydraulic force on the valve in operation is about 80 to 140 N. The hydraulic force relates to the pressure within the valve multiplied by the area of the ball.

As will be apparent to those skilled in the art, if the hydraulic force on the valve in operation is about 80 to 140 N, and the light spring, or other resilient element, has a spring rate/stiffness and preload as set out above, there is a difference of at least one order of magnitude between the hydraulic force and the biasing force caused by the resilient element. As such, the biasing force of the resilient element is sufficient to assist the supply ball in returning to the supply ball seat, but does not otherwise affect the operation of the valve.

Optionally, the valve is configured so that an internal pressure of the valve in operation is up to 100 kPa.

Optionally, a maximum biasing force exerted by the resilient element on the supply ball for biasing the supply ball towards the supply ball seat is less than 25% of a force required for reconfiguring the valve from the default position to the actuated position.

Further optionally, the maximum biasing force is less than 20% of the force required for reconfiguring the valve. Yet further optionally, the maximum biasing force is less than 19% of the force required for reconfiguring the valve. Yet further optionally, the maximum biasing force is less than 18% of the force required for reconfiguring the valve. Yet further optionally, the maximum biasing force is less than 15%, or less than 10%, or less than 5%, or less than 3%, of the force required to reconfigure the valve. Advantageously, this may prevent the resilient element from interfering with, or affecting, the operation of the valve.

Optionally, the maximum biasing force is between about 5% and about 22% of the force required to reconfigure the valve; or between about 8% and about 20% of the force required to reconfigure the valve; or about 9% or about 18% of the force required to reconfigure the valve.

Optionally, if a force of the resilient element acting on the supply ball in the default position is about 1 to 2 N, a force required to reconfigure the valve may be about 5 to 20 N, or about 10 to 12 N, or about 11.1 N.

Optionally, the valve further comprises an actuator coupled to the vent ball. This may advantageously allow the valve to function without relying on external components interacting with the valve.

Further optionally, the actuator is coupled to the vent ball so that actuation of the actuator causes the vent ball, the separator pin, and the supply ball to move so that the valve is reconfigured from the default position to the actuated position. This may result in reliable and simple reconfiguration of the valve from the default position to the actuated position.

Further optionally, the actuator is a solenoid configured so that when the solenoid is energised, the valve is in the actuated position, and when the solenoid is de-energised, the valve is in the default position. Advantageously, a solenoid is a widely available and inexpensive component which may be used to reliably actuate the valve.

Further optionally, the valve further comprises: a plunger configured to move upon energisation of the solenoid; a passage between the plunger and the vent ball; and a plunger pin provided in said passage, one end of the plunger pin configured to bear against the vent ball, and the other end of the plunger pin configured to be moved by the plunger when the solenoid is energised, so that upon energisation of the solenoid, the plunger moves the plunger pin, causing the vent ball, the separator pin, and the supply ball to move, so as to reconfigure the valve from the default position to the actuated position.

Although the two balls of the valve are referred to as a supply ball and a vent ball, this terminology is not intended to require any limitation of the functionality of the valve. For example, the supply ball and the vent ball may be simply considered a first ball and a second ball, or the positions of the vent ball and supply ball may be exchanged.

According to a second aspect of the present disclosure, there is provided a damper comprising a three-way valve according to the first aspect. The damper of the second aspect may in particular be a suspension damper.

It will be appreciated that features described in relation to one aspect of the present disclosure may also be applied equally to all of the other aspects of the present disclosure. Features described in relation to the first aspect of the present disclosure may be applied equally to the second aspect of the present disclosure and vice versa.

### BRIEF DESCRIPTION OF DRAWINGS

The disclosure will be further described, by way of example only, with reference to the accompanying drawings, in which:

FIG. 1 shows a cross-sectional view of an example three-way valve according to the disclosure;

FIG. 2 shows an enlarged cross-sectional view of the example three-way valve of FIG. 1; and

FIG. 3 shows an enlarged cross-sectional view of a portion of an example three-way valve.

### DETAILED DESCRIPTION OF DRAWINGS

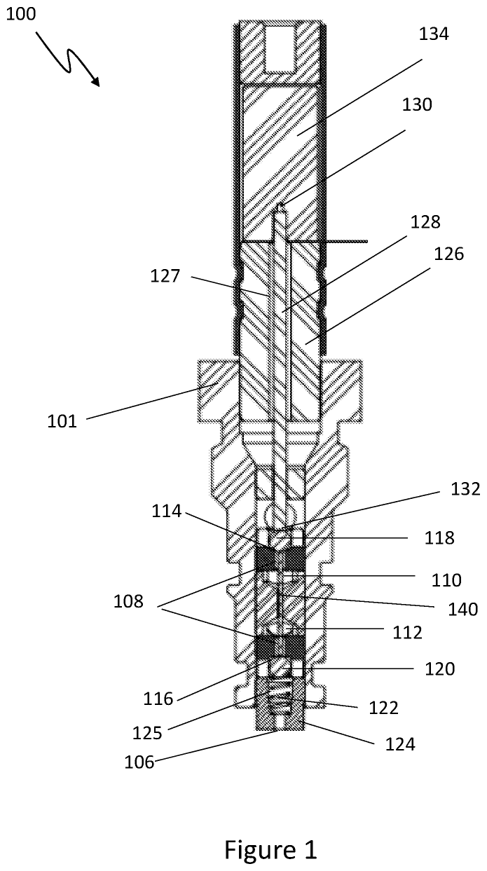

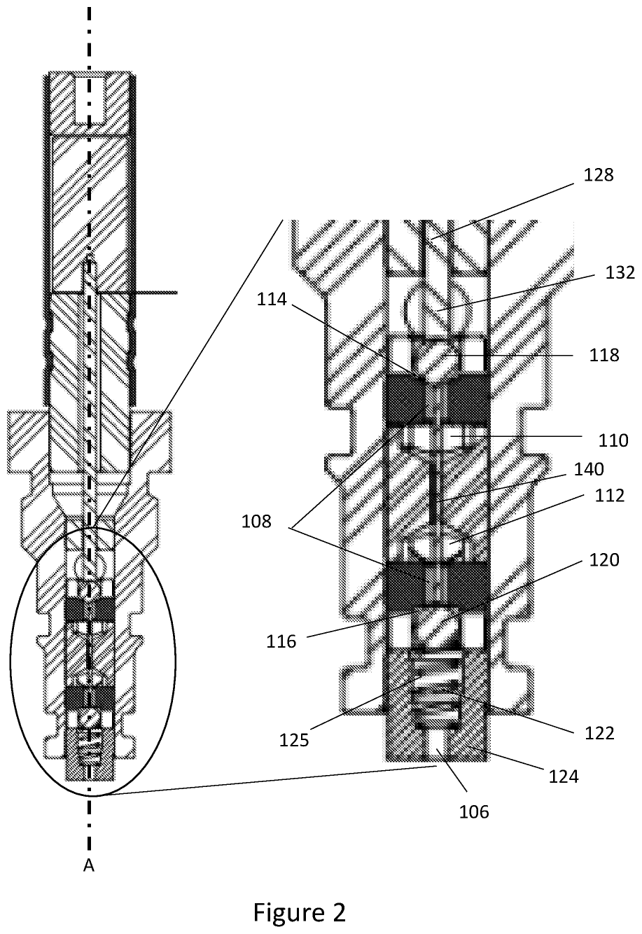

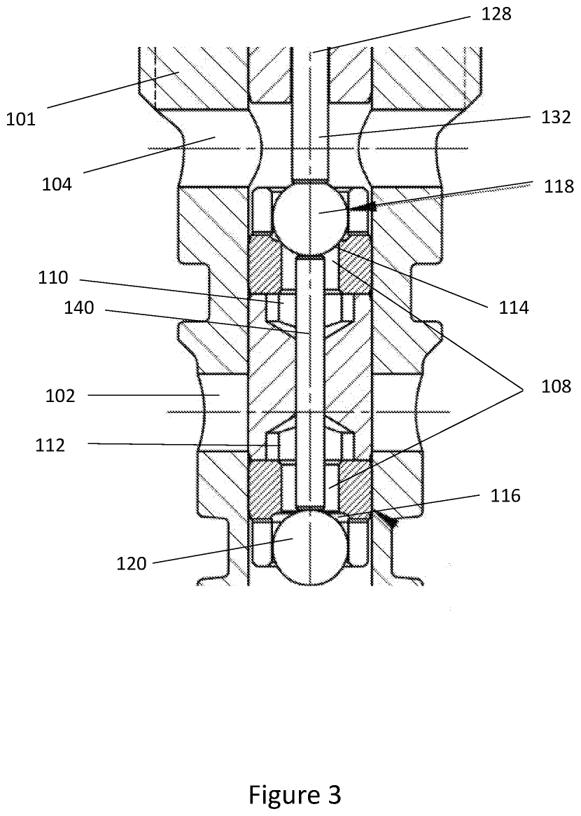

FIG. 1 and FIG. 2 show cross-sectional views of an example three-way valve 100 in accordance with the disclosure. The three-way valve 100 comprises a valve housing 101. The valve housing 101 comprises, as shown in FIG. 3, a valve inlet 102 through which fluid may enter the three-way valve 100 and two fluid outlets. The two fluid outlets are a vent outlet 104 (shown in FIG. 3) and a supply outlet 106 (shown in FIGS. 1 and 2) through which fluid may exit the valve element 100.

The valve housing 101 further includes a fluid flow path 108 disposed between the valve inlet 102 and the vent outlet 104 and the supply outlet 106.

The fluid flow path 108 comprises a first chamber 110, between the valve inlet 102 and the vent outlet 104, and a second chamber 112, between the valve inlet 102 and the supply outlet 106.

A vent ball seat 114 is provided about the circumference of the fluid flow path 108 adjacent the first chamber 110, and a supply ball seat 116 is provided about the circumference of the fluid flow path 108 adjacent the second chamber 112. The three-way valve 100 further comprises a vent ball valve element 118 and a supply ball valve element 120 disposed within the housing 101. The ball valve elements 118 and 120 will be referred to as vent ball 118 and supply ball 120 in the following. The diameters of the vent ball 118 and the supply ball 120 are larger than the diameter of the fluid flow path 108 adjacent the vent ball seat 114 and the supply ball seat 116.

The valve assembly 100 further comprises a coil spring 122 disposed adjacent the supply ball 120. The coil spring 122 is retained in a holder 124, having a cavity 125, in which the coil spring 122 is received. The coil spring 122 is arranged to lightly bias, or urge, the supply ball 120 onto the supply ball seat 116.

The coil spring 122 has a preload of about 2 N (0.4477 lbf) and a spring constant of about 2.2 N/mm (12.1 lbf/in). As the three-way valve 100 is configured so that a hydraulic force on the valve 100 in operation is about 110 N. As such, there is at least one magnitude difference between the hydraulic force and the biasing force of the light coil spring 122. The biasing force of the resilient element is therefore sufficient to assist the supply ball 120 in returning to the supply ball seat 116, but does not otherwise affect the operation of the three-way valve 100.

The diameter of the coil spring 122 is slightly smaller than the diameter of the supply ball 120, so that the supply ball 120 sits partly in the coil spring 122.

The three-way valve 100 further comprises a separator pin 140 between the vent ball 118 and the supply ball 120, and bears against the vent ball 118 and the supply ball 120. The separator pin 140 is configured to bear against the vent ball 118 and the supply ball 120 to functionally link the ball seats 114, 116, the balls 118, 120, and the separator pin 140, so that when one of the two balls 118, 120 is seated against the corresponding ball seat 118, 120, the other of the two balls 118, 120 is off its corresponding ball seat 114, 116.

The three-way valve 100 is a solenoid valve. As such, the three-way valve 100 further comprises a pole piece 126, the pole piece 126 comprising a cylindrical bore 127. The three-way valve 100 further comprises a drive pin 128 in the form of an elongate rod. The diameter of the cylindrical bore 127 is larger than the diameter of the drive pin 128 such that the drive pin 128 is able to move longitudinally through the pole piece 126.

The drive pin 128 has a first end 130 and a second end 132. The first end 130 of the drive pin 128 is configured to be engaged by an armature of the solenoid 134, and the second end 132 of the drive pin 128 is configured to engage the vent ball 118.

The solenoid 134, pole piece 126, drive pin 128, vent ball 118, vent ball seat 114, separator pin 140, supply ball seat 116, supply ball 116, spring 122, and holder 124 are all arranged along a longitudinal axis A.

In FIG. 3, the spring and retainer portion of the three-way valve has been omitted.

In use, the valve 100 may be in a default position, in which the vent ball 118 is pushed off the vent ball seat 114 by an internal operating pressure of the valve 100 of up to 100 kPa. In this default position, the solenoid 134 is de-energised. Because the vent ball 118 and the supply ball 120 are linked by the separator pin 140, as the vent ball 118 is pushed off the vent ball seat 114, the supply ball 120 is seated in the supply ball seat 116. Thus, the supply ball 120 forms a seal around the supply ball seat 116 to prevent fluid from passing from the fluid inlet 102 to the supply outlet 106.

When the solenoid 134 is energised, the armature of the solenoid 134 is moved towards the supply opening 106 by magnetic force, in turn urging the drive pin 128 towards the supply opening 106. The drive pin 128 is guided by the pole piece 126. The second end 132 of the drive pin 128 pushes the vent ball 118 onto the vent ball seat 114, so the vent ball 118 is seated in the vent ball seat 114. Thus, the vent ball 114 forms a seal around the vent ball seat 114 to prevent fluid from passing from the fluid inlet 102 to the vent outlet 104.

Because the vent ball 118 and the supply ball 120 are linked by the separator pin 140, as the vent ball 118 is pushed onto the vent ball seat 114, the supply ball 120 is pushed off the supply ball seat 116. As such, the supply ball 120 no longer forms a seal around the supply ball seat 116 so that fluid is allowed to pass from the fluid inlet 102 to the supply outlet 106.

At the same time, the light coil spring 122, guided by the holder 124, is compressed by the supply ball 120.

Once the solenoid 134 is de-energised, internal fluid pressure in the three-way valve 100 forces the vent ball 118 off the vent ball seat 114, at the same time forcing, or pulling, the supply ball 120 back onto the supply ball seat 116. This operation of the valve 100 is independent of the light spring 122, and is not affected by de-compression of the spring 122.

However, as the supply ball 120 is forced back onto the supply ball seat 116, the biasing force of the spring 122 is sufficient to ensure a consistent, and centred, return of the supply ball 120 to the supply ball seat 116.

Unlike in prior art three-way valves, even if the three-way valve 100 of the present disclosure is used in applications with significant environmental disturbance, the spring 122 which is centred on the longitudinal axis A, and the holder 124 which helps centre the spring 122 along the longitudinal axis A, ensure that the supply ball 120 returns to the supply ball seat 116, so that a response time of the valve 100 remains constant throughout operation.

1.-25. (canceled)

26. A three-way valve comprising:
a housing having three successive openings interconnected by a fluid flow path, the fluid flow path having:
a first chamber between a first and a second of the three successive openings, and
a second chamber between the second and a third of the three successive openings;
a vent ball and a corresponding vent ball seat adjacent the first chamber;
a supply ball and a corresponding supply ball seat adjacent the second chamber; and
a separator pin between, and configured to bear against, the vent ball and the supply ball, wherein the vent ball seat, the vent ball, the supply ball seat, the supply ball, and the separator pin are functionally linked so that when one of the vent ball and the supply ball is seated against the corresponding ball seat, the other of the vent ball and the supply ball is off its corresponding ball seat,
wherein the valve is configurable between a default position, in which the second opening is in fluid communication with the first opening, and an actuated position, in which the second opening is in fluid communication with the third opening,
wherein the valve further comprises:
a resilient element for biasing the supply ball towards the supply ball seat.

27. A three-way valve according to claim 26, wherein a maximum biasing force exerted by the resilient element on the supply ball for biasing the supply ball towards the supply ball seat is less than 25% of a force required for reconfiguring the valve from the default position to the actuated position.

28. A three-way valve according to claim 27, wherein the maximum biasing force is less than 20%, optionally between about 8% and about 20%, optionally about 9% or about 18%, of the force required for reconfiguring the valve.

29. A three-way valve according to claim 26, wherein a preload of the resilient element is between about 0.1 N and 10 N, optionally between about 0.5 and 5 N, optionally between about 1 N and 3 N, optionally between about 1.9 N and 2.1 N, further optionally wherein the preload of the resilient element is about 2 N.

30. A three-way valve according to claim 26, wherein the resilient element comprises a coil spring.

31. A three-way valve according to claim 30, wherein the coil spring is sized to receive a portion of the supply ball.

32. A three-way valve according to claim 31, wherein a diameter of the supply ball is larger than an internal diameter of the coil spring by about 1% to 50%, and optionally by about 34% than the internal diameter of the coil spring.

33. A three-way valve according to claim 30, wherein a spring constant of the coil spring is between about 1 N/mm and 5 N/mm, optionally between about 1.5 N/mm and 3 N/mm, optionally between about 2 N/mm and 2.5 N/mm, and further optionally about 2.2 N/mm.

34. A three-way valve according to claim 30, further comprising a holder for retaining the coil spring.

35. A three-way valve according to claim 34, wherein the holder comprises a cavity, and the coil spring is arranged within the cavity such that movement of the coil spring is guided by the holder.

36. A three-way valve according to claim 35, wherein the coil spring is fully retained within the cavity.

37. A three-way valve according to claim 26, wherein the resilient element comprises at least three, evenly distributed, elements, each having a resilient tip.

38. A three-way valve according to claim 37, wherein a diameter of the supply ball is larger than a diameter formed by the at least three resilient tips of the resilient element by about 1% to 50%, optionally larger by about 34%.

39. A three-way valve according to claim 26, wherein the valve is configured so that a hydraulic force on the valve in operation is about 80 to 140 N.

40. A three-way valve according to claim 26, wherein the valve is configured so that an internal pressure of the valve in operation is up to 100 kPa.

41. A three-way valve according to claim 26, further comprising an actuator coupled to the vent ball.

42. A three-way valve according to claim 41, wherein the actuator is coupled to the vent ball so that actuation of the actuator causes the vent ball, the separator pin, and the supply ball to move so that the valve is reconfigured from the default position to the actuated position.

43. A three-way valve according to claim 41, wherein the actuator is a solenoid configured so that when the solenoid is energised, the valve is in the actuated position, and when the solenoid is de-energised, the valve is in the default position.

44. A three-way valve according to claim 43, further comprising:
a plunger configured to move upon energisation of the solenoid;
a passage between the plunger and the vent ball; and
a plunger pin provided in said passage, one end of the plunger pin configured to bear against the vent ball, and the other end of the plunger pin configured to be moved by the plunger when the solenoid is energised, so that upon energisation of the solenoid, the plunger moves the plunger pin, causing the vent ball, the separator pin, and the supply ball to move, to reconfigure the valve from the default position to the actuated position.

45. A damper comprising a three-way valve according to claim 26.
